(19) United States
(12) Patent Application Publication
(10) Pub. No.: US 2008/0271350 A1
(43) Pub. Date: Nov. 6, 2008

(54) Procedure and Device for the Micro-Mixing of Fluids Through Reflux Cell

(76) Inventor: Alfonso Miguel Ganan Calvo, Sevilla (ES)

Correspondence Address: LADAS & PARRY LLP, 26 WEST 61ST STREET, NEW YORK, NY, 10023, US

(21) Appl. No.: 11/793,622

(22) PCT Filed: Jan. 16, 2006
(86) PCT No.: PCT/ES2006/000014

§ 371 Date: Feb. 19, 2008

(30) Foreign Application Priority Data
Jan. 17, 2005 (ES) P200500112
Apr. 18, 2005 (ES) P200500981

(51) Int. Cl. B05B 7/04; D06F 75/10; D06F 75/20

(52) U.S. Cl. 38/77.5; 239/338; 239/433

(57) ABSTRACT

Procedure and device for the micro-mixing of miscible or immiscible fluids through reflux cell, produced by the invasion of one of the fluids going upstream into the feeding tube of the other fluid. This tube is closed and has a tube exit which is placed opposite an area of confluence where the exiting flow of the intercepted fluid meets an approximately perpendicular current of invading fluid, which is radially and centripetally directed to the axis of this exiting flow. The product is released outside through an exit orifice. The edges of the tube exit and the exit orifice are opposite each other and separated by an axial gap; and the penetration of this reflux cell into the feeding tube is regulated by controlling the velocity of the fluid. An application of the invention is the ironing with a steam-aided water spray of drops smaller than 200 microns.

### DESCRIPTION OF THE INVENTION

1. Object of the Invention

The invention relates to a method and device for the micro-mixing of miscible or immiscible fluids using a reflux cell which is produced by the counter-current invasion by one of the fluids which penetrates upstream in the tube used to supply the other fluid. Said tube is closed and equipped with a discharge outlet which is positioned opposite a confluence area in which the outflow of the intercepted fluid is found which an essentially-perpendicular current of invading fluid that is directed radially and centripetally towards the axis of said outflow. The product is discharged freely to the exterior though an outlet orifice, the edges of the discharge outlet and the exit orifice being disposed opposite one another and separated by axial gap. through an exit orifice. The edges of the tube exit and the exit orifice are opposite each other and separated by an axial gap; and the penetration of this reflux cell into the feeding tube is regulated by controlling the velocity of the fluid. An application of the invention is the ironing with a steam-aided water spray of drops smaller than 200 microns.

2. State of the Art

The production of multiphase systems at a small scale is very interesting in many applications in pharmacy, food, agronomic and scientific industries. Among these multiphase systems we can find emulsions, foams or aerosols. Their production by purely fluid dynamic processes, particularly by pneumatic means, allows very different applications and developments in industry, technology, science and daily life. Aerosols have been used in various technological fields, particularly as a means to treat respiratory diseases through nebulization of liquid medicines. The administration of medicines through inhalation using aerosols allows to obtain appropriate concentrations of medicine in the respiratory system, minimizing side effects. In the same way, applications in the agronomic field are very well known, such as spraying pest-control substances as a part of a treatment of protection against insects. To do this, we use manual or automatic equipments which allow a targeted delivery and the capacity to control the size of drops, whose diameter usually varies between 100 and 500 microns. When drops sizes are inferior, between 50 and 100 microns, we usually use the term “nebulization”: when applying pest-control substances, it increases not only the capacity of flotation of the preparation but also the covered area when deposition of drops takes place.

There are several technological principles that could be applied to mixing (in the cases when the confluent phases are molecularly miscible) or the interpenetration of one or more phases. Some precedents based on purely fluid dynamic means are stated bellow. The technology called Flow Focusing (FF) (Gañán-Calvo 1998, Physical Review Letters 80, 285), through the use of a special geometry, uses pneumatic means in order to create micro-jets of liquid which lead to the formation of drops of a very small and substantially homogeneous size after passing through the exit orifice. This latest technology is able either to create micro-jets of liquid through another liquid instead of gas, or to generate micro-jets of gas inside a liquid (the same liquid or another different liquid used as an focusing liquid, that is to say, acting as the gas does in the pneumatic process), so that micro-bubbles of homogeneous sizes are created.

Later, the patent WO 0076673 (D1) suggested a configuration of flow, called violent flow focusing; As a marked difference with FF, the focusing gas has an essentially radial and centripetal flow (diaphragm-flow), concentrically directed in a thin layer which intercepts the exiting liquid in a surface of flow which is transversal to the axis of liquid movement. As it is explained in D1, the gas comes from a pressure camera, and the intense interaction produced between the liquid phase (whose movement is essentially axial) and the gaseous phase (radially directed) creates an immediate transference of a quantity of movement. As it is described in D1, however, the liquid comes outside as a jet. Moreover, this patent also states that the drops size has a very small dependence on the flow rate of the atomized liquid, at least within the parametric range of flow rates claimed. It is also important to emphasize that in D1 a relation between the average diameter of drops d and system parameters is claimed. Such system parameters are: the liquid flow rate Q, the applied pressure ΔP, and the physic properties of the liquid: density ρ and surface tension σ), given by:

d/dₒ≈(Q/Qₒ)^{1/5} (1)

where dₒ=σ/ΔP, and Qₒ=(σ⁴/(ρΔP³)^{1/2}. In D1 it is claimed that the liquid comes out through the exit orifice as a jet; if the diameter of this jet has the following expression (A. M. Gañán-Calvo 1998, Physical Review Letters 80, 218):

dⱼ≈(Q/Qₒ)^{1/2}dₒ (2)

then, the expression (1) would be perfectly justified through the pattern of turbulent mixture (in an area after the exit of the orifice) by Kolmogorov-Hinze (R. Shinnar, 1961, Journal of Fluid Mechanics 10, 259). Indeed, this theory states that the diameter of the drops produced by the turbulent broke is related to the macroscopic scale of the flow, which is dⱼ, according to the following expression:

d/dⱼ≈(dₒ/dⱼ)^{0.6} (3)

Combining the expressions (2) and (3) we obtain the expression (1). Data which have been stated in D1 agree very well with law (1), which agrees with the presence of the jet (which can be detected also through visual means). On the other hand, some geometric restrictions of the device are also stated so that the working of the system works according to what it is declared.

More recently, the application of Spanish patent number P200402333 (D2) whose title is “Device and process for the pneumatic atomization of liquids through the implosive flow of gas” describes devices and processes to atomize a liquid using a similar configuration of the present invention, restricted to the case of a circular tube exit and being the liquid phase surrounded by the gaseous phase while they go through the exit orifice. It describes also a variety of possible configurations to drive the liquid through the gaseous phase, which can be a vapour.

As a difference with those patents above, the invention described herein adds a modality of mixing that, on the one hand, allows the interaction of two or more arbitrarily chosen phases (it is not essential the restriction to a liquid jet in the centre with a gaseous current around); on the other hand, it is not based on the fragmentation of a jet that has been emitted by the central tube, but on a new principle: the invasion of this feeding tube by an invading stream coming from the external fluid. Therefore, the essential feature of the described process and device is the production of a reflux cell, where scales of turbulence are created ensuring in this way a closer interaction between the confluent phases. Therefore, the differences with patent D1 are (i) there is not a jet of one of the phases surrounded by the other phase, passing through an exit orifice, (ii) the geometric restrictions in D1 can not be applied to the present invention, and (iii) when using the present invention as a nebulizers of liquids, the obtained sizes of drops are much smaller (in some cases even five times smaller) than those described in D1.

Regarding steam-aided ironing with water spray, the first steam iron appeared in the middle sixties (U.S. Pat. No. 3,248,813). It consisted of an iron with a heat source inside generating a steam current which goes through a filter or diffuser as humidity drops. Another invention related to this one is an iron incorporating a water inlet device which conveys a water flow to a nebulizer used as a process of steam aided ironing (WO9800597), where the steam generator can be situated in an independent stand or inside the iron (WO9925915) and can be automatically filled. There are also previous works which use a system to generate the steam that will be conveyed to the iron through some pipes (WO02070812).

Unlike those previous inventions, the present invention includes a pneumatic nebulizer, where drops are generated from the turbulent mixture with water steam. This steam can either be directly generated through independent systems (either previous or not) of heat generation (e.g. electric), or either by means of the use of heat coming from the piece used to press while ironing. A way to do it, it would be by means of making the line of water expected to become steam pass through the area around this piece so that along its way the absorbed heat be enough to cause vaporization. The high velocity of the water at the moment of coming out of the spray caused by the methodology described above improves the features of ironing, in contrast to other methods.

### DESCRIPTION OF THE INVENTION

The object of the invention is a device of combination of phases for the mixing in the case of miscible fluids and for the production of emulsions, aerosols and microfoams in the case of immiscible fluids, by means of the creation of a reflux cell produced by the upstream invasion of one of the fluids (the one with lower density, referred to hereafter as invading fluid), that enters upstream into the feeding tube of the other fluid (the one with a higher density, referred to hereafter as intercepted fluid). This feeding tube is closed and has an exit; this tube exit is situated just opposite to an area of confluence where the exiting flow of the intercepted fluid meets an approximately perpendicular stream directed radially and centripetally to the axis of this exiting flow; the result of the interaction of both phases, mainly produced in this reflux cell, is freely released through an exit orifice that has approximately the same size than the tube exit; the edges of the tube exit and the exit orifice are in front of each other and separated by an axial gap; the penetration of this reflux cell in the feeding tube is regulated by controlling the velocity of the invading fluid in the confluence area, that should be at least twice higher and preferably at least five times higher than the velocity of the intercepted fluid in the feeding tube; the relation between velocities is obtained by means of an appropriate choice of the mass flow ratio of both phases, and also by means of the choice of the axial gap, that should be less than the half, and preferably inferior to a quarter of the diameter of the exit orifice.

Another variant of the invention is a device of combination of phases where the invading fluid is compound, consisting of several streams conformed by differentiated phases that interact with the current of the intercepted fluid in the reflux cell.

There is also described a device of combination of phases where the fluids are molecularly immiscible.

More specific forms of the invention lead to devices where the average inertia per unit volume of any of the phases at the confluence area and at the passage section of the exit orifice is at least twenty times (preferably one hundred times) higher than the average value per unit volume of the forces that are caused at the current due to the viscosity of the fluids at the confluence area and at the passage section of the exit orifice.

In other variant of the invention, the feeding tube of the intercepted fluid has a preferably circular section, as well as its tube exit and the exit orifice. The said tube exit is within a plane that is perpendicular to the symmetry axis of the tube; and that plane is parallel to the plane containing the exit orifice, and there exists an axial gap between both planes; the difference between the diameters of both the exit orifice and the tube exit is inferior to 20% of the largest diameter, and the centres of the tube exit and the exit orifice are aligned with a maximum error of 20% of the largest diameter.

Other additional modality is based in the fact that the invading fluid (or fluids) meet at the exit of the feeding tube of the intercepted fluid through one or more apertures perpendicularly positioned to face the axis of this tube, so that these apertures border on the tube exit on one side and on the exit orifice on the other side. The exit orifice is situated in front of the tube exit of the tube and the total area of these apertures is between 0.2 and 1.5 times, preferably between 0.5 and 1 time the area of the exit orifice.

In particular, a device for the mixing is described in this invention which makes two phases meet, being the densest phase a liquid and the least dense a gas, so that the gas to liquid mass flow ratio is between 0.01 y 10000, preferably between 0.05 y 200.

A preferential use of the described devices is the introduction of samples in atomic spectroscopy through this process; the intercepted fluid is a liquid phase containing samples to be characterized by optic or mass atomic spectroscopy, and the invading fluid is a gas, preferably argon.

On the other hand, the object of the invention is also a process of combination of phases for the mixing in the case of miscible fluids, and for the production of emulsions, aerosols and micro-foams in the case of immiscible fluids, based on the use of the device described above.

Another object of the invention is a device of ironing or “iron”, that consists of a pneumatic nebulizer to generate an aerosol of very thin drops by means of the mixing of liquid water and steam following the described configurations. This device is characterized by the fact that the invading fluid is steam generated through the application of heat to a current of liquid water, which is in fact the intercepted fluid. This heat used to vaporize water can come from the piece used to press the fabric in order to iron it. The generated drops impact against the fabric and their size can be controlled in order to improve the results of the ironing. The device can work with a mass flow rate of steam inferior to the half of the mass flow rate of the liquid water. This system allows a high saving of energy when compared with the conventional systems of ironing, which need much more energy to produce a complete vaporization of the liquid current. On the other hand, this system uses less energy since the proposed device needs for a fixed water flow rate the iron ejects only the vaporization of one fraction of it, reducing in this way energy consumption. Likewise, penetration of humidity in the fabric, and therefore effectiveness of the ironing, are increased thanks to the higher inertia of the aerosol, the small size of its drops and the high velocity of drops at the moment of coming out of the spray.

### DESCRIPTION OF THE FIGURES

Description of the figures captions

FIG. 1. Axi-symmetric configuration of the mixing device of the present invention as a liquid nebulizer. Grey arrows: Liquid to be atomized. Black arrows: Atomization gas.

FIG. 2. Four examples of mixing inside the tube, at the area around the tube exit (high speed pictures taken with a shutter speed of 0.1 microsecond, using a 4 Quick high speed video camera by Stanford Computer Optics), for the case of atomizing a liquid by means of gas and using an axi-symmetric configuration. Observe the formation of microscopic scales, bubbles of very different sizes and drops. The used liquid is water with 0.1% of Tween 80. The value for H is the distance between the exit of the feeding tube of the liquid and the exit orifice.

FIG. 3. Example of mixing inside the tube in the case of atomizing a liquid by means of gas and using an axi-symmetric configuration. In this case, the used liquid is 20° C. pure water, whose overpressure is ΔP=2500 millibars and whose liquid flow rate is Q=10 mL/min.

FIG. 4. Process of dynamic mixing at the area of confluence of phase 1 (denser) and phase 2 (less dense) and reflux to the phase 1 feeding tube, with three characteristic steps: (a) Formation of a stagnation point at the velocity field of fluid 2 between the tube exit and the exit orifice. The pressure begins to increase at the moment of going out of the tube. (b) Collapse of the inlet of the fluid 2 towards the tube by accumulation of fluid 1 at the tube exit. (c) Release of the accumulated fluid 2 together with fluid 1. Decrease of pressure at the tube exit.

### EXAMPLES OF THE CARRYING OUT OF THE INVENTION

### Example 1

### System of Pneumatic Atomization of Liquids

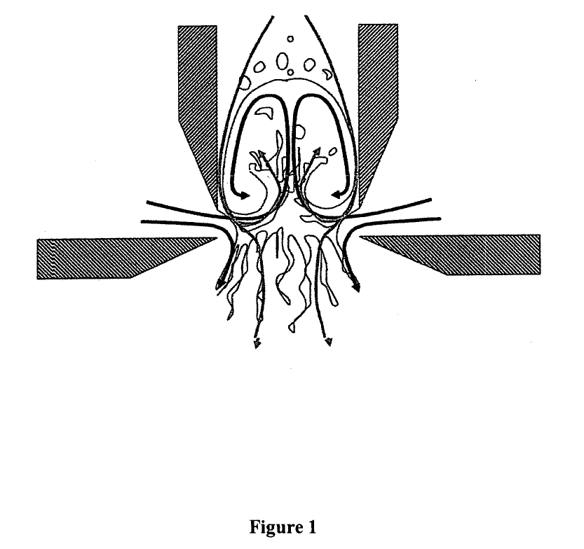

By means of the configuration shown in FIG. 1, with symmetry of revolution, the feeding tube of the liquid has a circular section and an interior diameter D. The said tube is inside a pressurized camera containing a gas which has one or more feeding inlets. The feeding tube exit is sharp-edged, as shown in the figure, and it is in front of another circular orifice with a diameter D situated on one of the walls of the camera, so that the planes containing the exit orifice of the camera and the exit of the feeding tube are parallel and separated by a distance H. This distance H is smaller than D/2, preferably smaller that D/4, so that the lateral ring-shaped section between the tube exit and the exit orifice has a passage area which is similar to the area of the exit orifice.

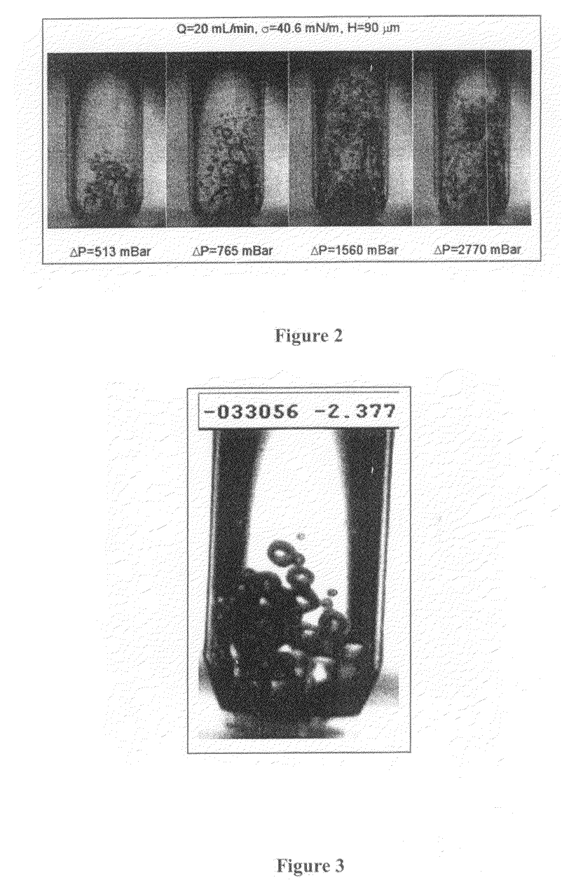

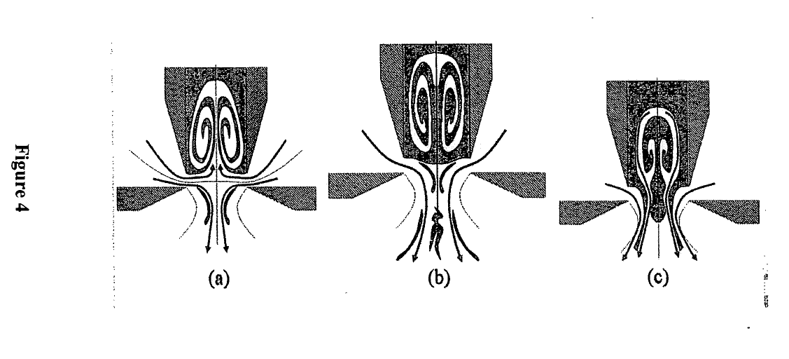

Due to the fact that the shape of the exit of the feeding tube of the liquid is sharp-edged, the lateral ring-shaped passage section of the gas already described makes easier a prompt gas release, with little or even no loses by friction. Consistently, the pressurized gas inside the camera will be released through the said section with the highest velocity the essentially adiabatic expansion allows (for a gap of pressures ΔP between the camera and the outside) up to the intermediate area situated between the tube exit and the exit orifice of the camera, as FIG. 1 shows. In this intermediate area a complex non-stationary distribution of pressures is produced as a consequence of: (i) the radial collapse at a high velocity of gas towards the axis of symmetry of the tube, causing a local increase of pressure at the area around the said axis of symmetry, and (ii) the liquid release through the tube being the liquid volume flow rate Q. The rise of local pressure at the area around the symmetry axis of the tube causes penetration of gas upstream the tube in the shape of a vertical jet that immediately opens up and becomes an area of toroidal vorticity (“mushroom” configuration) inside the tube, making its symmetry axis meet that of the tube, at the area around the tube exit (see FIG. 1). In this area a very turbulent movement takes place, generating microscopic mixing scales, bubbles and microscopic drops, and causing a violent mixing with the liquid coming from the tube (see FIGS. 2 and 3). In FIG. 3 we can observe how the liquid comes out at a high velocity from the tube exit in the shape of numerous thin liquid ligaments, before they pass through the exit orifice. This is an essential difference of the present invention in relation to the previous ones (D1 and D2).

### Example 2

### System of Liquids Mixing

By means of the configuration shown in FIG. 1, with symmetry of revolution, the feeding tube of the liquid has a circular section and an interior diameter D. The said tube is inside a pressurized camera containing another liquid which has one or more feeding inlets. The feeding tube exit is sharp-edged, as shown in the figure, and it is in front of another circular orifice with a diameter D situated on one of the walls of the camera, so that the planes containing the exit orifice of the camera and the exit of the feeding tube are parallel and separated by a distance H. This distance H is smaller than D/2, preferably smaller that D/4, so that the lateral ring-shaped section between the tube exit and the exit orifice has a passage area which is similar to the area of the exit orifice.

In this case where two liquid phases are mixed up, a possible flow pattern presenting three more or less cyclical moments is described in FIG. 4.

1. Device of combination of phases for the mixing in the case of miscible fluids and for the production of emulsions, aerosols and microfoams in the case of immiscible fluids, by means of the creation of a reflux cell produced by the upstream invasion of one of the fluids, the one with lower density (invading fluid) that enters upstream into the feeding tube of the other fluid, the one with a higher density (intercepted fluid) this feeding tube has an exit; this tube exit is situated just opposite to an area of confluence where the exiting flow of the intercepted fluid meets an approximately perpendicular stream directed radially and centripetally to the axis of this exiting flow; the result of the interaction of both phases, mainly produced in this reflux cell, is freely released through an exit orifice that has approximately the same size than the tube exit; the edges of the tube exit and the exit orifice are in front of each other and separated by an axial gap; the penetration of this reflux cell in the feeding tube is regulated by controlling the velocity of the invading fluid in the confluence area, that should be at least twice higher and preferably at least five times higher than the velocity of the intercepted fluid in the feeding tube; the relation between velocities is obtained by means of an appropriate choice of the mass flow ratio of both phases, and also by means of the choice of the axial gap, that should be less than the half, and preferably inferior to a quarter of the diameter of the exit orifice.

2. Device of combination of phases according to claim 1, characterized in that the invading fluid is compound, consisting of several streams conformed by differentiated phases that interact with the current of the intercepted fluid in the reflux cell.

3. Device of combination of phases according to claim 1, characterized in that fluids are molecularly immiscible.

4. Device of combination of phases according to claim 3, characterized in that the average inertia per unit volume of any of the phases at the confluence area and at the passage section of the exit orifice is at least twenty times, preferably one hundred times, higher than the average value per unit volume of the forces that are caused at the current due to the viscosity of the fluids at the confluence area and at the passage section of the exit orifice.

5. Device of combination of phases according to claim 3, characterized in that the feeding tube of the intercepted fluid has a preferably circular section, as well as its tube exit and the exit orifice; the said tube exit is contained within a plane that is perpendicular to the symmetry axis of the tube; and that plane is parallel to the plane containing the exit orifice, and there exists an axial gap between both planes; the difference between the diameters of both the exit orifice and the tube exit is inferior to 20% of the largest diameter, and the centres of the tube exit and the exit orifice are aligned with a maximum error of 20% of the largest diameter.

6. Device of combination of phases according to claim 3, characterized in that the invading fluid or fluids meet at the exit of the feeding tube of the intercepted fluid through one or more apertures perpendicularly positioned to face the axis of this tube, so that these apertures border on the tube exit on one side and on the exit orifice on the other side; the exit orifice is situated in front of the tube exit and the total area of these apertures is between 0.2 and 1.5 times, preferably between 0.5 and 1 time the area of the exit orifice.

7. Device of combination of phases according to claim 3, characterized in that two phases meet, being the densest phase a liquid and the least dense a gas, so that the gas to liquid mass flow ratio is between 0.01 y 10000, preferably between 0.05 y 200.

8. Device for the introduction of samples in atomic spectroscopy according to claim 3, characterized in that the intercepted fluid is a liquid phase containing samples to be characterized by optic or mass atomic spectroscopy, and the invading fluid is a gas, preferably argon.

9. Procedure of combination of phases for the mixing in the case of miscible fluids and for the production of emulsions, aerosols and microfoams in the case of immiscible fluids according to claim 3, characterised in that comprising the steps:
a. Supply of a flow rate of intercepted fluid to the tube or release part through the opposite side of the tube exit,
b. Supply of a flow rate of one or more invading fluids until they reach the area of the reflux cell,
c. Turbulent mixture of the fluids involved in the reflux cell and generation of a product that is dependent of the nature and miscibility of the fluids, and
d. The generated product comes outside through the exit orifice.

10. Device of ironing of fabrics, paper, sheets or films with a steam-aided water spray, characterized in that a device of combination of phases for water dispersion is incorporated, according claim 8; characterised in that the device is adapted to be ironed comprising a steam-aided water spray, which expels drops whose size is inferior to 200 microns.

11. Device of ironing with a steam-aided water spray according to claim 10, characterized in that the device of water dispersion is a pneumatic nebulizer where the driving gas is steam and the mass flow ratio between liquid water and steam is inferior to 0.5, preferably inferior to 0.15.

12. Device of ironing with a steam-aided water spray according to claim 11, characterized in that the absolute pressure of the steam which is used in the driving comprises from 1.5 bars to 12 bars.

13. Device of ironing with a steam-aided water spray according to claim 12, characterized in that it incorporates a boiler whose capacity is between 20 and 5000 cubic centimetres, where water temperature can be regulated between 110° C. and 187° C.

14. Device of ironing with a steam-aided water spray according to claim 13, characterized in that the feeding tube of water and the steam feeding tube start from the internal areas which are situated, respectively, in the lowest and highest vertical levels of the boiler and go towards the pneumatic nebulizer incorporated in the iron.

15. Device of ironing with a steam-aided water spray according to claim 14, characterized in that the feeding tube of water goes along the internal part of the ironing surface or iron base.

16. Process of ironing with a steam-aided water spray according to claim 15, characterised in that comprising the steps:
a. Water supply from a tank to the nebulizer,
b. Steam supply from a system of steam generation to the nebulize.
c. Mixing of both phases and generation of an aerosol of thin drops that come out of the nebulizer at a high velocity, and
d. Impact of the aerosol over the fabric, paper, sheet or film to be ironed.
